(19) United States
(12) Patent Application Publication
(10) Pub. No.: US 2008/0010246 A1
(43) Pub. Date: Jan. 10, 2008

(54) SYSTEM AND METHOD FOR PROVIDING OPERATING SYSTEM COMPONENT VERSION VERIFICATION

(76) Inventors: BRYCE A. CURTIS, Round Rock, TX (US); VINCENT J. MERIWETHER, Round Rock, TX (US)

Correspondence Address: IBM CORPORATION (SWP), C/O SUITER SWANTZ PC LLO, 14301 FNB PARKWAY, SUITE 220, OMAHA, NE, 68154-5299, US

(21) Appl. No.: 11/428,930

(22) Filed: Jul. 6, 2006

(51) Int. Cl. G06F 17/30

(52) U.S. Cl. 707/3

(57) ABSTRACT

The present invention is a method for providing operating system component version verification for a computer system. The method includes storing operating system component version data. The method further includes receiving a query requesting the operating system component version data. The method further includes processing the query. The method further includes accessing the operating system component version data. The method further includes communicating the operating system component version data. The operating system component version data is stored in non-volatile memory of the computer system, the non-volatile memory being accessible to each operating system installed on the computer system.

### FIELD OF THE INVENTION

The present invention relates to the field of network computing security and particularly to a system and method for providing operating system (OS) security verification.

### BACKGROUND OF THE INVENTION

A critical step to securing a computer from viruses and attacks in a network is ensuring that the operating system(s) of the computer is/are up-to-date. As part of this updating process, patches (i.e., service patches) and updates may be downloaded frequently to ensure that the computer's operating system has the latest fixes for new viruses, worms and Trojan Horses. Given the importance of updating, it is crucial to consistently verify the security state or level of the computer's operating system to determine which patches and updates have been applied. Such verification provides a way of ensuring that updating has been diligently performed (i.e., that the most recent patches and updates have been applied). Unfortunately, verification of the security state or level of a computer's operating system is currently a difficult and time-consuming process. This difficulty is compounded when a computer is configured with multiple operating systems. For example, operating system component version verification in a computer having multiple operating systems (such as a dual-boot system) may be hindered when an operating system to be verified is not being run by the computer at that time. Further, operating system component version verification may also be hindered when the computer is in a powered off mode or hibernating mode.

Therefore, it may be desirable to have a system and method for providing operating system component version verification which addresses the above-referenced problems and limitations of the current solutions.

### SUMMARY OF THE INVENTION

Accordingly, an embodiment of the present invention is directed to a method for providing operating system component version verification for a computer system. The method includes storing operating system component version data. The method further includes receiving a query requesting the operating system component version data. The method further includes processing the query. The method further includes accessing the operating system component version data. The method further includes communicating the operating system component version data. The operating system component version data is stored in non-volatile memory of the computer system, the non-volatile memory being accessible to each operating system installed on the computer system.

In a further embodiment, the present invention is directed to a system for providing operating system component version verification. The system includes: a first computer system configured for storing operating system component version data in non-volatile memory of the first computer system, the operating system component version data providing at least one of identification of software updates which have been applied to an operating system of the first computer system and identification of service patches which have been applied to an operating system of the first computer system; and a second computer system communicatively coupled to the first computer system via a network, the second computer system configured for directing a query to the first computer system requesting the operating system component version data of the first computer system, wherein the first computer system is configured for retrieving the operating system component version data and communicating the operating system component version data to the second computer system in response to receiving the query, the operating system component version data being accessible to each operating system installed on the first computer system.

In an additional embodiment, the present invention is directed to a computer system for providing operating system component version verification. The computer system includes: non-volatile memory configured for storing operating system component version data of the computer system, the operating system component version data providing at least one of identification of software updates which have been applied to an operating system of the first computer system and identification of service patches which have been applied to an operating system of the first computer system, wherein the computer system is configured for retrieving and providing the operating system component version data in response to receiving a query for said data, the operating system component version data being accessible to each operating system installed on the computer system.

It is to be understood that both the foregoing general description and the following detailed description are exemplary and explanatory only and are not necessarily restrictive of the invention as claimed. The accompanying drawings, which are incorporated in and constitute a part of the specification, illustrate embodiments of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 is a block diagram illustration of a system for providing operating system component version verification in accordance with an exemplary embodiment of the present invention;

FIG. 2 is a block diagram illustration of a computer system for providing operating system component version verification in accordance with an exemplary embodiment of the present invention; and

FIG. 3 is a flow chart illustrating a method for providing operating system component version verification for a computer system in accordance with an exemplary embodiment of the present invention.

### DETAILED DESCRIPTION OF THE INVENTION

Reference will now be made in detail to the presently preferred embodiments of the invention, examples of which are illustrated in the accompanying drawings.

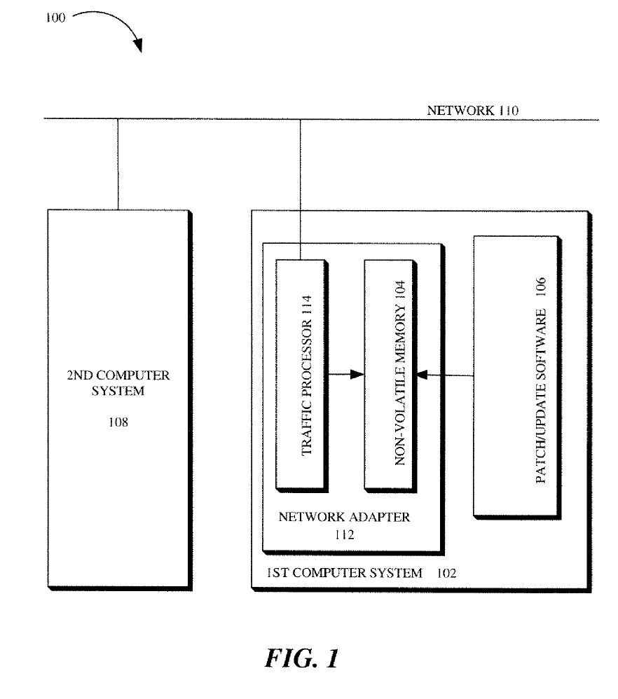

FIG. 1 illustrates a block diagram configuration for a system 100 for providing operating system component version verification in accordance with an exemplary embodiment of the present invention. In a present embodiment, the system 100 includes a first computer system 102 configured for storing operating system component version data in non-volatile memory 104 of the first computer system 102. In exemplary embodiments, the operating system component version data may provide identification of software updates which have been applied to one or more operating systems of the first computer system 102. In further embodiments, the operating system component version data may provide identification of service patches which have been applied to one or more operating systems of the first computer system 102. In additional embodiments, the operating system component version data may be used for security validation. In still further embodiments, the operating system component version data may be used for validation of the level/version of other operating system components that do not affect security of the first computer system. Further, the operating system component version data may reflect the level of all patches for one or more operating systems of the first computer system 102. For instance, patch/update software 106 may install/apply a service patch or software update to one or more operating systems of the first computer system 102. Further, one or more entries identifying operating systems, instances and service patch or software updates (i.e., the operating system component version data) may be written to and stored in the non-volatile memory 104. The operating system component version data may be stored in a variety of formats (text, binary, or the like) in the non-volatile memory. For example, the operating system component version data may be formatted as name/value pairs, such as (property n, value n). For instance, to indicate that service patch “Q12345” for operating system “Windows XP” and instance “1” has been installed on the first computer system 102, the name/value pair (Windows XP/1/patches, Q12345) may be utilized. Alternatively, the name/value pair (Windows XP/1/patch/Q12345, true) may be utilized, the word “true” serving to indicate that the service patch has been installed on the first computer system 102. Although various formats for storing operating system component version data may be utilized, it may be beneficial to utilize a standardized format across industry.

In the present embodiment, the system 100 further includes a second computer system 108 communicatively coupled to the first computer system 102 via a network 110. For instance, the network 110 may be a Local Area Network (LAN), a Wide Area Network (WAN), or the like. The second computer system 108 is configured for directing a query to the first computer system 102 requesting the operating system component version data of the first computer system 102. For instance, a query may be made by the second computer system 108 to determine which and/or if certain patches are installed on the first computer system 102. In an exemplary embodiment, the query may include a property name to be retrieved. For instance, to obtain the identity of all patches installed on an operating system of the first computer system 102, the query may include a request for “Windows XP/1/patches”.

In current embodiments, the first computer system 102 is configured for retrieving the operating system component version data in response to receiving the query. Further, the first computer system 102 is configured for communicating the retrieved operating system component version data to the second computer system 108. For instance, for a query including a request such as “Windows XP/1/patches”, described above, the retrieved and communicated operating system data may include identities/identifiers (ex.—“Q123445”) of all patches installed on the Windows XP operating system of the first computer system 102. In the exemplary embodiments, the operating system component version data is accessible to each operating system installed on the first computer system 102.

In further embodiments, the first computer system 102 is further configured for updating the operating system component version data. For example, patch/update software 106 of the first computer system 102 may provide the updating functionality. In exemplary embodiments, the first computer system 102 may update the operating system component version data when a service patch is installed on the first computer system 102. In additional embodiments, the first computer system 102 may update the operating system component version data when a software update is installed on the first computer system 102.

In exemplary embodiments, the non-volatile memory 104 of the first computer system 102 includes memory of a network adapter 112. In additional embodiments, the non-volatile memory of the first computer system 102 may be hardfile, flash memory, a BIOS (Built-In Operating System) of the first computer system 102 or the like. In further embodiments, the network adapter 112 includes a traffic processor 114 configured for processing the query directed to the first computer system 102. The traffic processor 114 is configured for retrieving operating system component version data from the memory 104 of the network adapter 112.

In additional embodiments, the first computer system 102 is configured for retrieving and communicating the operating system component version data to the second computer system 108 in response to receiving the query, even when the first computer system 102 is in a hibernating mode or a powered-off mode. In further embodiments, the first computer system 102 may include multiple operating systems, such as in a dual-boot or multi-boot configuration. In embodiments in which the first computer system 102 includes multiple operating systems, the first computer system 102 is configured for retrieving and communicating operating system component version data pertaining to operating systems which may be installed, but are not being run at the time of the query, to the second computer system 108.

In further embodiments, the second computer system 108 may be a router, which may obtain operating system component version data from the first computer system 102. In embodiments where the network 110 implements packet switching, the router, once provided with the operating system component version data from the first computer system 102, may inventory the data (to see if and/or what patches/updates have been applied) and limit which packets are allowed to/from the first computer system 102 based on said data. In additional embodiments, network access for the first computer system 102 may be restricted until certain service patches and/or updates are applied to the first computer system 102, thereby serving to protect the first computer system 102 from computer viruses, attacks and the like via the network 110. In still further embodiments, service patches and/or updates may be supplied to the first computer system 102 by a router, a separate computer system communicatively coupled to the first computer system 102 via a Local Area Network (LAN), or a remote computer system communicatively coupled to the first computer system 102 via a Wide Area Network (WAN).

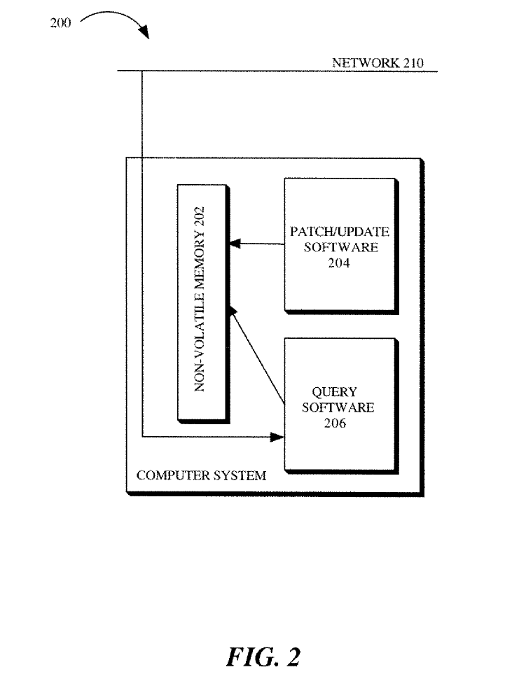

FIG. 2 illustrates a block diagram configuration of a computer system 200 for providing operating system component version verification in accordance with an exemplary embodiment of the present invention. In a present embodiment, the computer system 200 includes non-volatile memory 202 configured for storing operating system component version data of the computer system 200. In exemplary embodiments, the operating system component version data may provide identification of software updates which have been applied to one or more operating systems of the computer system 200. In further embodiments, the operating system component version data may provide identification of service patches which have been applied to one or more operating systems of the computer system 200. For instance, patch/update software 204 may install/apply a service patch or software update to one or more operating systems of the computer system 200. Further, an entry identifying the operating system instance and the service patch or software update may be written to and stored in the non-volatile memory 202.

In further embodiments, the computer system 200 is configured for retrieving and providing the operating system component version data in response to receiving a query for said data. In additional embodiments, the query may be processed and/or the operating system component version data may be retrieved by query software 206 of the computer system 200. In the illustrated embodiment, the operating system component version data is accessible to each operating system installed on the computer system 200.

In an exemplary embodiment, the query for operating system component version data of the computer system 200 may originate from the computer system 200. In further embodiments, the query may originate from a source system 208 (not shown) communicatively coupled with the computer system 200 via a network 210.

In current embodiments, the computer system 200 is further configured for updating the operating system component version data when a service patch is installed on the computer system 200. In additional embodiments, the computer system 200 is configured for updating the operating system component version data when a software update is installed on the computer system 200.

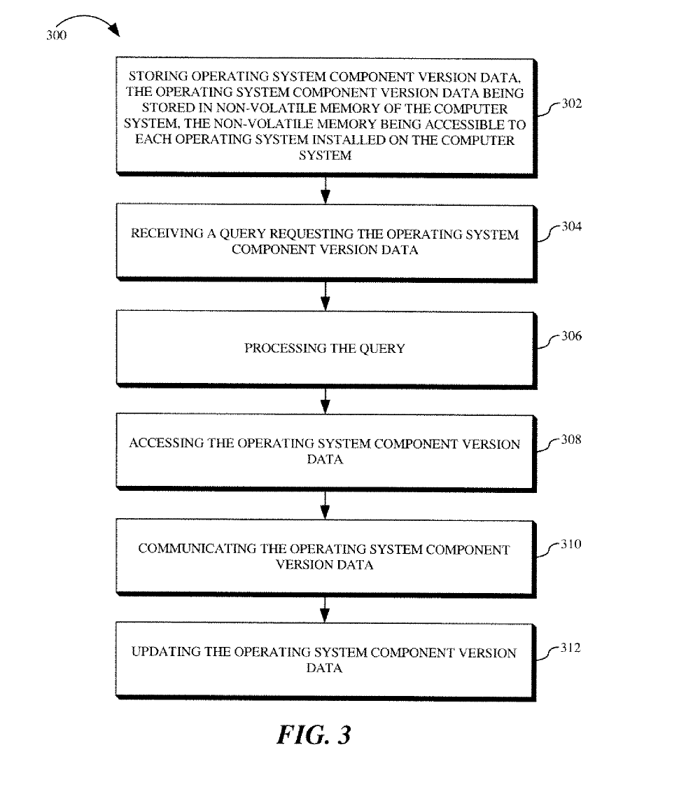

FIG. 3 is a flow chart illustrating a method for providing operating system component version verification for a computer system. The method 300 includes storing operating system component version data 302. In exemplary embodiments, operating system component version data may provide identification of software updates which have been applied to an operating system of the computer system. In further embodiments, operating system component version data may provide identification of service patches which have been applied to an operating system of the computer system. In current embodiments, the operating system component version data is stored in non-volatile memory of the computer system. In additional embodiments, the non-volatile memory is accessible to each operating system installed on the computer system. In an exemplary embodiment, the non-volatile memory includes memory of a network adapter.

The method 300 further includes receiving a query requesting the operating system component version data 304. In a present embodiment, the query may be received from a source system, the source system being communicatively coupled with the computer system via a network. The method 300 further includes processing the query 306. The method 300 further includes accessing the operating system component version data 308. The method 300 further includes communicating the operating system component version data 310. The method 300 further includes updating the operating system component version data 312.

It is contemplated that the invention may take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention may take the form of a computer program product accessible from a computer-usable or computer-readable medium providing program code for use by or in connection with a computer or any instruction execution system. For the purposes of this description, a computer-usable or computer readable medium may be any apparatus that may contain, store, communicate, propagate, or transport the program for use by or in connection with the instruction execution system, apparatus, or device.

It is further contemplated that the medium may be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements may include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, microphone, speakers, displays, pointing devices, and the like) may be coupled to the system either directly or through intervening I/O controllers.

Network adapters may also be coupled to the system to enable the data processing system to connect to other data processing systems or storage devices through intervening private or public networks. Telephone modems, cable or DSL modems and Ethernet cards are just a few of the currently available types of network adapters.

It is understood that the specific order or hierarchy of steps in the foregoing disclosed methods are examples of exemplary approaches. Based upon design preferences, it is understood that the specific order or hierarchy of steps in the method can be rearranged while remaining within the scope of the present invention. The accompanying method claims present elements of the various steps in a sample order, and are not meant to be limited to the specific order or hierarchy presented.

It is believed that the present invention and many of its attendant advantages are to be understood by the foregoing description, and it is apparent that various changes may be made in the form, construction and arrangement of the components thereof without departing from the scope and spirit of the invention or without sacrificing all of its material advantages. The form herein before described being merely an explanatory embodiment thereof, it is the intention of the following claims to encompass and include such changes.

What is claimed is:

1. A method of providing operating system component version verification for a computer system, comprising:
storing operating system component version data;
receiving a query requesting the operating system component version data;
processing the query;
accessing the operating system component version data; and
communicating the operating system component version data,
wherein the operating system component version data is stored in non-volatile memory of the computer system, the non-volatile memory being accessible to each operating system installed on the computer system.

2. A method as claimed in claim 1, further comprising:
updating the operating system component version data.

3. A method as claimed in claim 2, wherein the operating system component version data provides at least one of: identification of software updates which have been applied to an operating system of the computer system and identification of service patches which have been applied to an operating system of the computer system.

4. A method as claimed in claim 1, wherein the non-volatile memory includes memory of a network adapter.

5. A method as claimed in claim 1, wherein the query is received from a source system, the source computer system being communicatively coupled with the computer system via a network.

6. A computer program product, comprising:
a computer useable medium including computer usable program code for performing a method for providing operating system component version verification for a computer system, the computer program product including:
computer usable program code for storing operating system component version data;
computer usable program code for receiving a query requesting the operating system component version data;
computer usable program code for processing the query;
computer usable program code for accessing the operating system component version data;
computer usable program code for communicating the operating system component version data,
wherein the operating system component version data is stored in non-volatile memory of the computer system, the non-volatile memory being accessible to each operating system installed on the computer system.

7. A computer program product as claimed in claim 6, further comprising:
computer usable program code for updating the operating system component version data.

8. A computer program product as claimed in claim 7, wherein the operating system component version data provides at least one of: identification of software updates which have been applied to an operating system of the computer system and identification of service patches which have been applied to an operating system of the computer system.

9. A computer program product as claimed in claim 6, wherein the non-volatile memory includes memory of a network adapter.

10. A computer program product as claimed in claim 6, wherein the query is received from a source system, the source computer system being communicatively coupled with the computer system via a network.

11. A system for providing operating system component version verification, comprising:
a first computer system configured for storing operating system component version data in non-volatile memory of the first computer system, the operating system component version data providing at least one of identification of software updates which have been applied to an operating system of the first computer system and identification of service patches which have been applied to an operating system of the first computer system; and
a second computer system communicatively coupled to the first computer system via a network, the second computer system configured for directing a query to the first computer system requesting the operating system component version data of the first computer system,
wherein the first computer system is configured for retrieving the operating system component version data and communicating the operating system component version data to the second computer system in response to receiving the query, the operating system component version data being accessible to each operating system installed on the first computer system.

12. A system as claimed in claim 11, wherein the first computer system is further configured for updating the operating system component version data when at least one of a service patch and a software update is installed on the first computer system.

13. A system as claimed in claim 11, wherein the non-volatile memory of the first computer system includes memory of a network adapter.

14. A system as claimed in claim 13, wherein the network adapter includes a traffic processor for processing the query directed to the first computer system.

15. A system as claimed in claim 14, wherein the traffic processor of the network adapter is configured for retrieving operating system component version data from the memory of the network adapter.

16. A system as claimed in claim 15, wherein the first computer system is configured for retrieving and communicating the operating system component version data to the second computer system in response to receiving the query when the first computer system is in one of: a hibernating mode and a powered off mode.

17. A computer system for providing operating system component version verification, comprising:
non-volatile memory configured for storing operating system component version data of the computer system, the operating system component version data providing at least one of identification of software updates which have been applied to an operating system of the first computer system and identification of service patches which have been applied to an operating system of the first computer system,
wherein the computer system is configured for retrieving and providing the operating system component version data in response to receiving a query for said data, the operating system component version data being accessible to each operating system installed on the computer system.

18. A computer system as claimed in claim 17, wherein the query originates from the computer system.

19. A computer system as claimed in claim 17, wherein the computer system is further configured for updating the operating system component version data when at least one of a service patch and a software update is installed on the computer system.

20. A computer system as claimed in claim 17, wherein the query is received from a source system communicatively coupled via a network.
